(19) United States
(12) Patent Application Publication
(10) Pub. No.: US 2002/0033415 A1
(43) Pub. Date: Mar. 21, 2002

(54) Secondary security measure for transaction cards

(76) Inventor: Pamela Robin Cummins, Port Macquarie (AU)

Correspondence Address: David S. Jacobson, 65 Woods End Road, Stamford, CT, 06905, US

(21) Appl. No.: 09/848,192

(22) Filed: May 3, 2001

Related U.S. Application Data
(63) Continuation-in-part of application No. 09/664,690, filed on Sep. 19, 2000.

(51) Int. Cl. G06F 17/60

(52) U.S. Cl. 235/379

(57) ABSTRACT

Disclosed is a secondary security measure for transaction cards such as credit cards, debit cards or other cards used in ATMs or across the counter at a bank for example. The secondary measure is a secondary security code that is derived from the date of birth of the card holder's mother or father. As well as the primary security code required to initiate a transaction, the secondary security code would be required to finalise the transaction.

This application is a Continuation-in-part of U.S. patent application Ser. No. 09/664,690 filed Sep. 19, 2000.

### FIELD OF THE INVENTION

The following invention relates to transaction cards such as credit cards, debit cards, ATM (Automatic Teller Machine) cards and other cards that might be used over the counter and/or with machines or of other devices such as card readers to transact finds. Such cards require entry of a PIN (Personal Identification Number), or other security code as a security measure to initiate a transaction at ATMs or when making a purchase where one slides his or her own card through a card reader associated with a key pad such as in supermarkets or other stores, for example. Such a PIN or other security code might be termed a “primary PIN” or “primary security code”.

Where a credit card is used to purchase goods for example, only a signature is required for verification. A PIN or other security code is not required for this type of transaction. Therefore any person capable of forging a signature appearing on a stolen card can use the cad to make a purchase.

### OBJECT OF THE INVENTION

It is the object of the present invention to overcome or substantially ameliorate at least one of the above disadvantages and/or more generally to provide a secondary security measure for transaction cards.

### DISCLOSURE OF THE INVENTION

There is disclosed herein a transaction system using a transaction card encoded to identify an account or accounts with which the transaction card is associated and with which there is associated a primary security code, entry of which is required by a card holder to perform a transaction when using the card with ATMs or other devices, the system further requiring the entry of a secondary security code derived from the date of birth of the card holder's mother or father to perform a transaction.

Typically, only the day and month of the date of birth of the card holder's mother or father need be entered.

The card holder's mother or father's date of birth data might be held in a database, having been placed there upon opening of the account with which the card is associated. Other information held in the database might include the card holder's mother's maiden name for example.

The primary security code is required when a transaction is being made with a machine such as an ATM or supermarket or other store card reader. When making a transaction with a credit card ever the counter the primary security measure might instead use a signature verification. In such transactions, the secondary security code is required to complete a transaction.

There is further disclosed herein a transaction system using a transaction card encoded to identify an account or accounts with which the transaction card is associated, the card having a signature thereon and the system incorporating secondary encoding derived from the date of birth of the card holder, the system requiring signature verification and verification of the secondary encoding to complete a transaction.

### DESCRIPTION OF THE PREFERRED EMBODIMENTS

Known transaction cards are encoded with a magnetic strip to identify the account or accounts with which the card is associated. Information is held in a computer database and usually includes a PIN code. Entry of this code is required to commence a transaction when using the card at an ATM or when using “EFTPOS” (Electronic Funds Transfer Point of Sale) facilities at supermarkets or other stores for example.

If the card is stolen and the PIN is known by the thief, the card can readily be used. However, with secondary encoding, relating to the date of birth of the card holder's mother or father, the secondary encoding can readily be recalled by the legitimate card holder and entered as a secondary security measure at an ATM or card reader or during an across the counter transaction. A thief would not necessarily know the date of birth data.

The invention utilises both primary and secondary encoding in the bank's database, with the primary encoding being an ordinary PIN, but the secondary encoding being something like “03221935” to identify the date of birth of a card holder's mother or father born on Mar. 22, 1935. The entry of this code would be required as a secondary security measure to complete a transaction at an ATM or EFT terminal or else the relevant date of birth might simply be stated to a shop assistant who can key in the code. Without both the signature or primary code and the secondary code, the transaction will be withheld by the bank's computer software.

It should be appreciated that the secondary PIN or other security code need not be exactly as stated above but might simply be “derived” from the date of birth of the card holder's mother or father. It might, for example, just be in relation to the month and day of the month for card holders not willing to divulge their age at every across the counter transaction

It should be appreciated that alterations to this system that are obvious to those skilled in the art are not to be considered as beyond the scope of the invention. For example, the secondary encoding might also include a check digit as a further security measure against unauthorised use. It will also be understood that reference to the birth date of the card holder's mother or father includes reference to the birth date of a guardian or a step-mother or step-father.

It should further be appreciated that where people carry multiple cards and have multiple accounts, these often have different PINs and it can be difficult and confusing to remember them all. As a result and despite requests from the financial institutions issuing the cards, it is common for people to keep written record of their various PINs in their wallet or purse. This presents a substantial risk of fraudulent use of the card if the wallet or purse is lost or stolen. In the present invention, the secondary PIN being a derivation of one of the card holder's parents date of birth would be easy to remember by the legitimate card holder. There would be further advantages in that there would be no need for the card holder to write this number down on material kept with their wallet or purse as it would be readily recalled anyway.

As a preferred or optional feature, an ATM might be pre-programmed to retain the transaction card, should a user not be able to key in the secondary security code.

If the holder's purse or wallet is stolen, the action card would be of no use or value to a thief, even if the primary PIN is discovered. If the thief then attempted to use the card to purchase goods over the counter without the secondary PIN, the transaction could not be completed. If the thief attempted to use the card in an ATM, his lack of information as to one of the card holder's parent's date of birth would result in cancellation of a transaction and perhaps retention of the card by the ATM.

There is further provided a method of entering the secondary PIN into the financial institution's database without human intervention on behalf of the financial institution:

Contrary to current practice, all application forms for issuance of a card would be individually coded with an application number or similar.

Each application form would have a “tear-off” section, containing the same coding as the body of the form. This removable section would also contain instructions for the card applicant to set up the secondary PIN by telephoning the credit provider at a specified telephone number within a specified time period (eg. 48 hours from lodging the card application), using a touch-tone phone. The instructions would explain the nature and use of the secondary security code. The card applicant's telephone call is answered by an automated answering service which prompts the caller to enter the individual application form coding and the birth date which will form the basis for the secondary PIN. The service will then confirm this data to the caller, for example by asking for repeat entry of the data or confirming the data by voice synthesis. The automated service may optionally then confirm to the caller the secondary PIN derived from the birth data.

When the application is processed by the credit provider, the secondary PIN is correlated to the card application in the database using the application form code number, thus entering the secondary PIN into the database without intervention by staff of the credit card provider.

Where a card applicant completes an application form and lodges it personally with the credit provider, facilities may be provided to complete this secondary PIN set up procedure at that time. If the applicant mails in the application, the applicant will need access to a touch-tone phone to complete set up of the secondary PIN.

The system may also require that the applicant, upon receipt of the credit or transaction card, telephones the card provider on a specified telephone number and is prompted to key in the PIN to activate the card.

I claim:

1. A transaction system using a transaction card encoded to identify an account or accounts with which the transaction card is associated and with which there is associated a primary security code, entry of which is required by a card holder to perform a transaction when using the card with ATMs or other devices, the system further requiring the entry of a secondary security code derived from the date of birth of the card holder's mother or father to perform a transaction.

2. A transaction system according to claim 1 including application forms containing individual application codes and instructions for a card applicant to complete set up of said secondary security code by entering said application form code and the birth date from which the secondary security code is derived.

3. A transaction system according to claim 2 the card holder is required to contact the credit provider and cause entry of the secondary security code before said card is activated for initial use.

4. A transaction system using a transaction card encoded to identify an account or accounts with which the transaction card is associated, the card having a signature thereon and the system incorporating secondary encoding derived from the date of birth of the card holder's mother or father, the system requiring signature verification and verification of the secondary encoding to complete a transaction.

5. A transaction system according to claim 4 including application forms containing individual application codes and instructions for a card applicant to complete set up of said secondary security code by entering said application form code and the birth date from which the secondary security code is derived.

6. A transaction system according to claim 5 the card holder is required to contact the credit provider and cause entry of the secondary security code before said card is activated for initial use.
